(19) United States
(12) Patent Application Publication
(10) Pub. No.: US 2003/0220787 A1
(43) Pub. Date: Nov. 27, 2003

(54) Method of and apparatus for pitch period estimation

(76) Inventors: Henrik Svensson, Lund (SE); Mattias Hansson, Lund (SE); Jan Aberg, Lund (SE); Fisseha Mekuria, Lund (SE)

Correspondence Address: JENKENS & GILCHRIST, 3200 Fountain Place, 1445 Ross Avenue, Dallas, TX, 75202-2799, US

(21) Appl. No.: 10/408,477

(22) Filed: Apr. 7, 2003

Related U.S. Application Data
(60) Provisional application No. 60/374,039, filed on Apr. 19, 2002.

(51) Int. Cl. G10L 11/04

(52) U.S. Cl. 704/207

(57) ABSTRACT

A pitch period of a signal is estimated by identifying a peak candidate of the signal as a peak and estimating the pitch period of the signal based on a time difference between the identified peak and a previous peak of the signal. An error-concealment apparatus includes a history block for storing signal data input to a decoder, an error likelihood detector, and a pitch period estimator. The error likelihood detector directs an input of the decoder to data of the signal data in the history block offset an estimated signal pitch period back in time responsive to a determination that data from a receiver has been lost or corrupted. The pitch period estimator estimates the pitch period of the signal via identification of peaks of the signal data.

### RELATED APPLICATIONS

This patent application claims priority from and incorporates by reference the entire disclosure of U.S. Provisional Patent Application No. 60/374,039, which was filed on Apr. 19, 2002.

### BACKGROUND OF THE INVENTION

1. Technical Field of the Invention

The present invention relates in general to pitch period estimation (PPE) and more particularly, to pitch period estimation for use in pitch period error concealment (PPEC) systems. The PPEC systems can be used in voice processing systems. For example, the PPEC systems can be used to eliminate voice impact of 2.4 GHz band interference in systems that utilize BLUETOOTH.

2. Description of Related Art

In data connections, transmission of data is likely to be impaired by interference. In voice links in ad hoc wireless networks such as BLUETOOTH, interference is likely from microwave ovens, other BLUETOOTH links, or wireless transmission systems that operate in the frequency band of 2400-2500 MHz. An 802.11b wireless local area network (WLAN) operating near a BLUETOOTH voice link typically causes a packet loss rate of 5-20%, which packet loss rate renders speech quality unacceptable. Interference often occurs in the shape of short error-bursts (i.e. short periods where received data contain virtually no transmitted information and are more or less random). If the data represent audio signals and corrupted data are fed directly into an audio decoder, an annoying crackling noise typically results. If the loss of information is detected, the missing or corrupted voice data can be replaced by other data that are fed into the audio decoder in order to avoid the crackling noise. For example, corrupted or lost frames of coded data representing voice signals can be replaced with silence code (known in the art as muting) or with previously-received frames of coded data (known in the art as code repetition).

In the case of muting, a silence code can be fed into the audio decoder when loss of data has been detected. In the case of continuous variable slope delta modulation (CVSD) coding, the silence code is made up of alternating bits (‘101010 . . . ’). The silence code makes the decoder produce silence (i.e., zero sound signal samples). The decoder output signal gradually decays to zero, so that annoying crackles caused by discontinuities between the silence code and the received coded data are avoided.

FIG. 1 is a block diagram of a system 100 that includes an error-concealment block 102. A muting pattern 0101 . . . is fed from a block 104 of the error concealment block 102 to a continuous variable slope delta modulation (CVSD) decoder 106 via a switch 108 in order to handle lost voice packets for a duration of the lost packets. If a packet with a decidable header (for example, correct CRC) is received by a receiver 110, the packet is passed to the CVSD decoder 106 via the switch 108. If, on the other hand, the header is corrupt, the muting pattern is passed to the decoder via the switch 108. The system 100 also includes a receiver 110. The receiver 110 can input to the error concealment block 102 CVSD data or an indication that a packet has been lost or corrupted. A system utilizing an error-concealment block like the error-concealment block 102 is shown and described in PCT Patent Application No. PCT/NL01/00873, entitled Method for replacing corrupted audio data, and filed on Nov. 30, 2001. This application incorporates the entire disclosure of PCT/NL01/00873 by reference.

In the case of code repetition, the corrupted data is replaced by earlier correctly-received data in order to attempt to maintain the characteristics of the audio signals at the decoder output, based on an assumption that the audio signal has not changed too much during that short time. Furthermore, for example, lost or corrupted Pulse Code Modulation (PCM) data packets (i.e., uncoded data) can be replaced by repeating PCM samples from a previous pitch period as often as needed to fill in a lost frame.

However, the approaches described above are disadvantageous for several reasons. First, although replacement of the missing or corrupted voice data results in better sound quality than use of the corrupted data, which results in crackling noise, the resulting output voice signal often sounds rough. In the case of muting, the annoying crackling noise is removed, but the output audio signal still sounds rough because of the inserted silent periods. The silent periods are especially distinguishable in audio signals representing speech and, more particularly, voiced speech (e.g., vowel sounds, such as ‘a’, ‘e’, and ‘i’) due to abrupt amplitude changes in the signal waveform.

If replacement of lost or corrupted data by a preceding packet is used, phase errors might occur in the resulting output audio signal. The phase errors are caused by the length of the replaced data, because the length generally does not correspond to the pitch period of the audio signal represented by the data. The resulting output audio signal sound might sound even rougher than a voice signal in which the muting mechanism is applied.

Furthermore, repeating output samples generally results in discontinuities at the borders of the repeated audio parts. Since the discontinuities are clearly audible, extra measures are needed to resolve the discontinuities. Moreover, if the audio signals are coded, at the end of an error burst the state of the decoder registers is generally incorrect. As a consequence, an output error generally occurs after repeating output samples, unless extra measures are taken to update the decoder registers after an error burst.

In an effort to improve the quality of signals that have been degraded by interference, a CVSD error concealment solution has been proposed. Part of the proposed CVSD error concealment solution is a pitch period estimator (PPE). The PPE is used to estimate a pitch period T_{pitch} of the speech signal. The estimated pitch period is used to keep a read pointer in a history buffer at an offset of T_{pitch}·fₛ samples back in time. When data is lost at any instance in time, error concealment can be carried out by replacing lost data with data from the history buffer.

There are numerous ways to estimate the pitch period of a speech signal. The problem is general and can be valid for any quasi-stationary signal. A stationary signal is a signal in which probabilistic properties of the signal do not change over time. A quasi-stationary signal is a signal that is substantially stationary when observed in a short time interval. Speech signal waveforms are composed of quasi-stationary regions and noise-like regions. Quasi-stationary speech segments represent speech signal regions (e.g., vowel sounds) with periodically (pitch-wise) repeating waveform regions at slowly-varying pitch periods. Different approaches to pitch period estimation can be divided into three main categories: 1) exploration of time-domain properties of the signal; 2) exploration of frequency-domain properties of the signal; and 3) exploration of the time-domain properties and the frequency-domain properties of the signal.

Schemes that explore the frequency-domain properties tend to be inefficient in terms of processing capacity. For an embedded BLUETOOTH system, for example, a scheme with low complexity is desirable in order to fulfill all necessary requirements with low impact on footprint size. Low complexity also facilitates mapping of the scheme to only hardware, to only software, or to a mix of hardware and software.

Existing pitch-period estimation solutions tend toward being too complex. A too-complex solution tends to add an audio-path delay in the audio path if mapped into a software solution or an excessively-large footprint if mapped to a hardware solution.

A pitch-period estimation scheme with very low complexity is needed in order to reduce necessary processing capacity, to facilitate a relatively-small-footprint hardware implementation, and to prevent a computational delay in the voice path in a software solution. A low-complexity scheme, as well as a scheme that provides a very reliable estimation of the pitch period at any instance in time and for all types of quasi-stationary speech signals, is needed. Therefore, a method of and apparatus for pitch period estimation that eliminate the drawbacks mentioned above and other drawbacks is needed.

### SUMMARY OF THE INVENTION

These and other drawbacks are overcome by embodiments of the present invention, which provides a method of and apparatus for pitch period estimation. In an embodiment of the present invention, a method of estimating a pitch period of a signal includes identifying a peak candidate of the signal as a peak and estimating the pitch period of the signal based on a time difference between the identified peak and a previous peak of the signal. In another embodiment of the present invention, an error-concealment apparatus includes a history block for storing signal data input to a decoder and an error likelihood detector for directing an input of the decoder to data of the signal data in the history block offset an estimated signal pitch period back in time responsive to a determination that data from a receiver has been lost or corrupted. The error-concealment apparatus also includes a pitch period estimator for estimating the pitch period of the signal via identification of peaks of the signal data. The pitch period estimator is operative to identify a peak candidate of the signal data as a peak and determine a time difference between the identified peak and a previous peak of the signal data.

### BRIEF DESCRIPTION OF THE DRAWINGS

A more complete understanding of exemplary embodiments of the present invention can be achieved by reference to the following Detailed Description of Exemplary Embodiments of the Invention when taken in conjunction with the accompanying Drawings, wherein:

FIG. 1, previously described, is a block diagram of a system that includes an error concealment block;

FIG. 2 is a block diagram of a system in which an error concealment block in accordance with principles of the present invention replaces the error concealment block shown in FIG. 1;

FIGS. 3A-3C are graphs that illustrate application of steps 402-406 of FIG. 4; in accordance with principles of the present invention;

FIG. 4 is a flow diagram that illustrates an overall functional flow per PCM sample in accordance with principles of the present invention; and

FIG. 5 is a graph of a speech signal that illustrates a threshold adjustment scheme in accordance with the present invention.

### DETAILED DESCRIPTION OF EXEMPLARY EMBODIMENTS OF THE INVENTION

Time-domain properties of a speech signal can be explored in order to perform pitch-period estimation. Different approaches based on speech-signal time-domain properties include: 1) measuring time between significant signal peaks, 2) counting signal zero crossings; 3) maximizing a short-time auto-correlation function; and 4) minimizing a short-time average magnitude difference function (AMDF).

Embodiments of the present invention use time-domain properties of the speech signal to estimate the pitch period of the speech signal. In accordance with principles of the present invention, a time period between two subsequent zero crossings (that possess certain properties) of PCM samples of the speech signal is determined. Using zero crossings of the speech signal decreases noise impact. The noise is more apparent in the time domain when the derivative of the signal is near zero. However, a skilled person will realize that the algorithm can easily be altered to determine a time period between two subsequent peaks instead. The algorithm can estimate the pitch period from two non-adjacent peaks or zero crossings in those cases in which not every peak or zero crossing is identified. Embodiments of the present invention can be applied in a sample-by-sample manner, which means that it is unnecessary to store incoming PCM data for the purpose of pitch period estimation.

The pitch period estimate is given in number of samples (N_{pitch}). A conversion can be performed to seconds (T_{pitch}) by converting using a sample rate (fₛ), such that:

$${T}_{pitch} = \frac{{N}_{pitch}}{{f}_{s}} \qquad ( 1 )$$

One area in which principles of the present invention can be applied is relative to a BLUETOOTH voice link operating near a 802.11b wireless local area network (WLAN). An 802.11b WLAN operating near a BLUETOOTH voice link typically causes a packet loss rate of 5-20%, which packet loss rate renders speech quality unacceptable. One proposed solution to this packet-loss problem has involved error concealment in a continuous variable slope delta modulation (CVSD) bit stream on a receiving side of the BLUETOOTH link. The proposed CVSD error-concealment solution can be implemented in a voice block in accordance with principles of the present invention.

A central function of the current CVSD error-concealment solution is a pitch period estimator (PPE). The PPE is used to estimate a pitch period (T_{pitch}) of a speech signal. The estimated pitch period is used to keep a read pointer in a history buffer at an offset of T_{pitch}·fₛ samples back in time. When data is lost at a given instance in time, error concealment can be carried out by replacing the lost data with data from the history buffer.

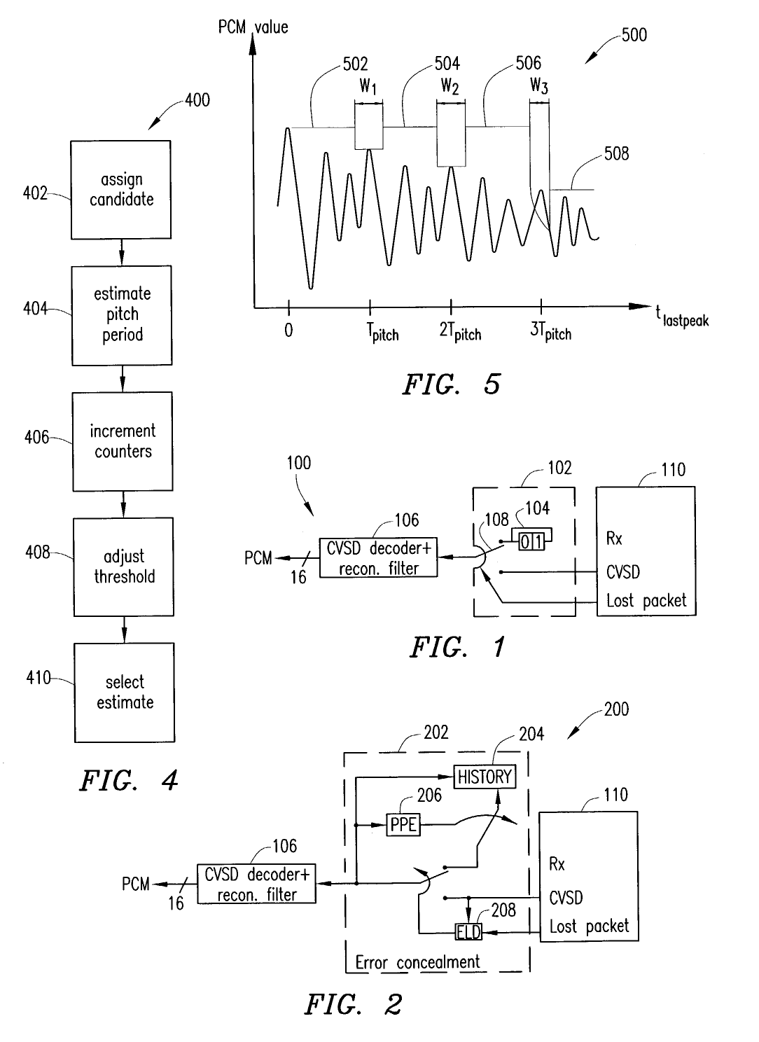

FIG. 2 is a block diagram of a system 200 in which an error concealment block 202 in accordance with principles of the present invention replaces the error concealment block 102 shown in previously-described FIG. 1. The error concealment block 202 includes three primary components: a history buffer 204; a PPE 206; and an error likelihood detector (ELD) 208. The history buffer 204 contains the N_{pitchmax} bits most recently fed into the CVSD decoder 106. Bits fed into the history buffer 204 may come either from the receiver 110 or be looped back from earlier history.

The PPE 206 maintains an estimate of the pitch period T_{pitch} of the speech signal at all times. The pitch period is used to keep a read pointer of the history buffer 204 at an offset of N_{pitch} samples back in time. The ELD 208 is used to determine whether CVSD data from each received packet has been lost or corrupted by channel errors. If so determined, the ELD 208 redirects an input to the CVSD decoder 106 from received data to historical data from one (estimated) pitch period back, thus creating a replacement frame that is likely to be similar to the discarded one.

The PPE 206 operates to identify peaks of the speech signal. The pitch period T_{pitch} is then estimated to be a distance between two consecutive peaks of the same polarity (i.e., two consecutive positive peaks or two consecutive negative peaks), or rather the distance between the first zero crossings following the respective peaks.

When a pitch period estimator, such as, for example, the PPE 206, is not turned off when the signal is not quasi-stationary (i.e., when the signal is noise-like), the pitch period estimator is still processing the signal (without obtaining any valid pitch-period estimate). A decision block that detects whether or not the signal is quasi-stationary (voiced/unvoiced) can be introduced to address this problem. Based on a determination regarding whether or not the signal is quasi-stationary, the pitch-period estimator can be turned on and off.

FIG. 4 is a flow diagram that illustrates an overall functional flow per PCM sample in accordance with principles of the present invention. The flow 400 begins at step 402. At step 402, a candidate is assigned. An incoming PCM sample is assigned as a peak candidate if a value of the peak candidate exceeds an old peak candidate value and a number of samples N_{pitchmin} has passed since a peak was last determined. In addition, a timestamp, referred to as a candidate position, for the event is set to zero. The term timestamp is used in the sense that, if the sample rate is known, it is sufficient to use a sample number as the time resolution.

Step 404 includes a threshold-based scheme that is used to estimate the pitch period. A new pitch period is computed if the peak candidate exceeds a threshold value and a current pcm sample value is less than or equal to zero (i.e., a zero crossing is reached). Pitch period is a value computed from the time counter peak position, which is a multiple of the actual pitch period. At step 404, the following operations are also performed if a pitch period was computed:

peak←peak candidate

pitch period←peak position div n or k

since last peak←candidate position

peak position←0

candidate position←0

peak candidate←0

n and k are integers depending on peak position and pitch period. In embodiments of the present invention, peak and peak candidate are PCM sample values. Since last peak, peak position, and candidate position are time counters, in number of samples, that are incremented for every sample. At step 406, counters are incremented. Using a relative notation of time leads to:

since last peak←since last peak+1

peak position←peak position+1

candidate position←candidate position+1

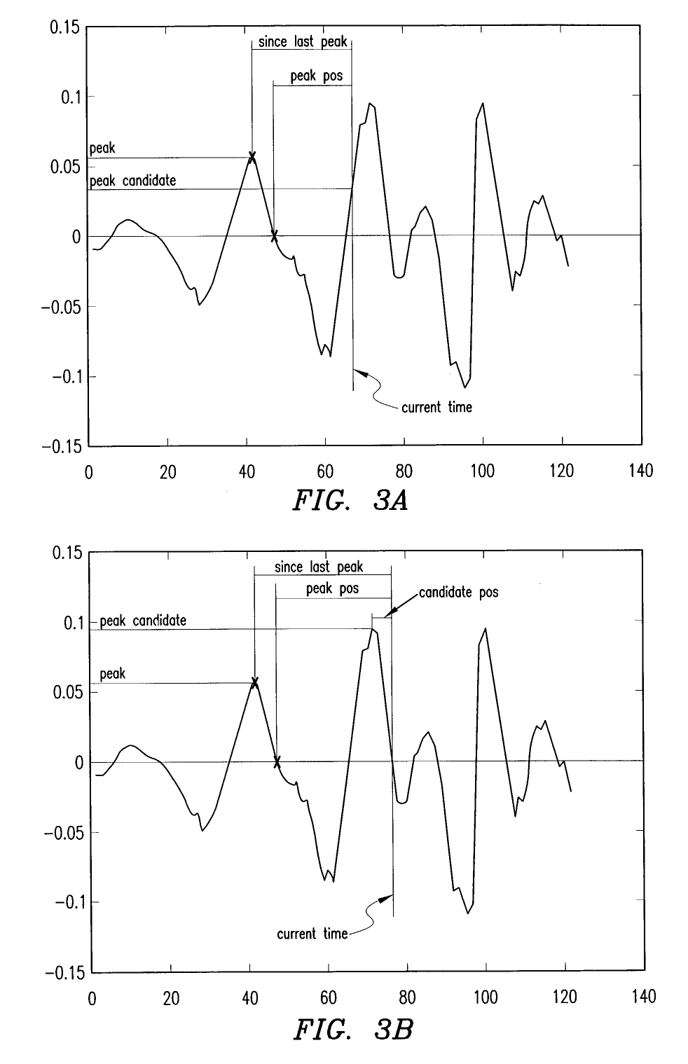

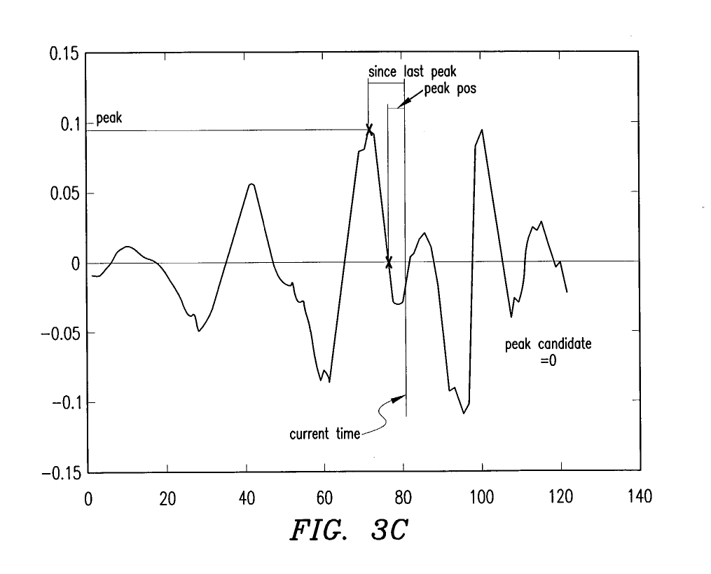

FIGS. 3A-3C are graphs that illustrate application of steps 402-406 in accordance with principles of the present invention. Referring now to FIGS. 3A-C and 4, when a zero crossing has been reached and the peak candidate exceeds a threshold value, the peak candidate is recognized as a peak (step 402). In FIGS. 3A-C, the latest peak and the subsequent zero crossing are each marked with an X. If a peak was recognized, the pitch period is estimated (step 404) via the counter peak position, which is the time between the two recognized zero crossings. The counter since last peak is updated to the time between the peak and the zero crossing, which has been tracked by candidate position. Since last peak is used for threshold determination. Peak position, candidate position, and peak candidate are set to zero. See FIG. 3C.

Then, for each PCM sample, a determination is made whether the sample is a peak candidate and, in that case, the counter candidate position is set to zero. In FIG. 3A, the current sample is a peak candidate. In FIG. 3B, the latest peak candidate is the value that will soon (i.e., at the next zero crossing) be recognized as a peak and the current sample value is smaller than that value. In FIG. 3C, the peak candidate has been set to zero (at the zero crossing) and no sample value has been greater than zero so far. Each time a sample is checked, the counters since last peak, peak position, and candidate position are incremented (step 406).

At step 408, a pitch-period-estimation threshold is adjusted. A latest-found peak value peak as well as the estimated pitch period and the counter since last peak are used at step 408 to adjust/control the threshold. The threshold is adapted so that reliable pitch period estimates are delivered on increasing as well as decreasing speech-signal envelopes. Equations (2)-(5) below represent a set of rules to that are used in accordance with principles of the present invention to control/adjust the threshold. The counter since last peak is designated nₗₐₛₜₚₑₐₖ and the pitch period is designated N_{pitch} below.

FIG. 5 is a graph of a speech signal 500 that illustrates the threshold adjustment scheme in accordance with the present invention. Windows W₁, W₂, W₃ that result from Equation (3) and (4) below are shown. Thresholds 502, 504, 506, and 508 that result from Eq. (2) are also shown.

First, the threshold is adjusted when a new peak has been found and a new pitch period estimate has been computed, such that:

threshold=K_{A}·peak (2)

The threshold is reduced (Wₙ of FIG. 5, n=1,2) when a new peak is expected; that is, when:

$$\begin{matrix}{n}_{lastpeak} ∈ [ n \cdot {N}_{pitch} - {N}_{n} , n \cdot {N}_{pitch} + {N}_{n} ] su ch that \\ threshold = {K}_{n} \cdot threshold\end{matrix} \qquad ( 3 )$$

where n is a set of positive integers, Nₙ is a time uncertainty and Kₙ represents corresponding threshold factors at particular instances in time. If a peak is found in a window Wₙ, the pitch period estimate is calculated as peak position div n.

At some instant in time, there is a need to reduce the threshold to a reset value (Wₖ of FIG. 5, k=3) if no peaks have been found during some pre-defined time period; that is, when:

nₗₐₛₜₚₑₐₖ>k·N_{pitch}−Nₖ,k>n.

This can be done, for example, as:

threshold=Kₖ⁽ⁿ^{ₗₐₛₜₚₑₐₖ}^{-(k·N}^{_{pitch}}^{-N}^{ₖ}⁾⁾·threshold (4)

or as

threshold=Kₖ·threshold (5)

where k is a positive integer; Nₖ is a time uncertainty factor, and Kₖ is a corresponding threshold factor at the particular instance in time. If a peak is found in the window Wₖ, the pitch period estimate is calculated as: peak position div k. When entering a window Wₙ or Wₖ, the peak candidate is reset to zero. Using the notation applied to step 408, if, for example: n=[1,2]; k=3; N₁=N₂=N₃=10 samples; K_{A}=K₁=⅞; and K₂=K₃=⅝; threshold adjustments are as shown in FIG. 5, where peaks are found at tₗₐₛₜₚₑₐₖ=0 and tₗₐₛₜₚₑₐₖ=3T_{pitch}.

In order to increase the reliability of the pitch period estimate, in embodiments of the present invention, estimation is performed for both positive and negative peaks. In order to avoid a footprint increase of a hardware implementation due to estimation being performed for both positive and negative peaks, the scheme can be applied to negative samples by converting to positive arithmetic. When the scheme is applied to negative samples by converting to positive arithmetic, logical blocks can be shared; however, two sets of counters and appropriate sample values must be stored. Performing a pitch period estimation on both positive and negative peaks has been shown to be a good feature, since it is often easier to perform a threshold-based estimation of the pitch period on either positive or negative peaks. Whether a threshold-based pitch period estimation based on positive or negative peaks is more accurate changes between various speech segments in a speech signal.

At step 410, a selection between a pitch period estimate based on positive pcm values and a pitch period estimate based on negative pcm values occurs. The pitch period can also be a combination thereof, as described in more detail below. In embodiments of the present invention, steps 402-408 are performed to estimate the pitch period on both positive and negative peaks. At step 410, the same arithmetic explained with respect to steps 402-408 is employed by separating the negative and the positive PCM values and by using absolute values (i.e., the absolute-value approach). An attractive property of the absolute-value approach, if implemented as hardware (e.g., ASIC), is that it is possible to share logic between the two estimations of the pitch period. The absolute-value approach can be performed using the following rules:

If pcm sample≧0, pcm sample positive=pcm sample.

If pcm sample<0, pcm sample positive=0.

If pcm sample<0, pcm sample negative=|pcm sample|.

If pcm sample≧0, pcm sample negative=0.

The steps of the absolute-value approach are performed on pcm sample positive if the current pcm sample is positive and on pcm sample negative if the current pcm sample is negative; thus, two different pitch period estimates to select between result therefrom: N_{uppitch} and N_{downpitch}. Therefore, there is a need for some sort of selection criteria to calculate an output of the flow 400 (i.e., N_{pitch})

A simple solution is to use the latest calculated estimate (N_{uppitch} or N_{downpitch}) as an output of the flow 400; however, in that case, the benefit of using the two-estimate-solution is in some sense lost. One possible solution is to use the maximum of the two estimates:

$${N}_{pitch} = max \{ {N}_{uppitch ,} {N}_{downpitch} \} \qquad ( 7 )$$

where N_{uppitch} is the pitch period estimate using pcm sample positive and N_{downpitch} is the pitch period estimate using pcm sample negative. Many other solutions are possible, such as choosing N_{pitch} based on N_{uppitch}, N_{downpitch} and the most recent previous value of N_{pitch}.

The calculation of the maximum of the positive pitch period and the negative pitch period could possibly be performed when a new peak is found in any instance in time. However, when a peak is found outside the window Wₙ, it is very likely to be at the beginning of a quasi-stationary part of the speech curve or when the read pointer of the history buffer has lost track of the pitch period. It is then profitable to keep the old estimate N_{pitch} as the output of the flow 400, or use the estimate that is found within window Wₙ. This can also be applied when there is an indication that the algorithm has failed (e.g., when no peaks have been found during a pre-defined time period).

Depending on the constants used in the flow 400, even multiples of the pitch period, N_{pitch}, can be found, which is a satisfactory characteristic when used in a system for pitch period error concealment (PPEC). Table 1 shows constants and exemplary corresponding values that can be used in the flow 400. The values shown in Table 1 have been adapted to reduce complexity in a hardware implementation:

[image]

Pitch period estimation in the context of BLUETOOTH systems has been discussed in detail herein. However, it will be appreciated that principles of the present invention can be applied to any speech processing system with quasi-stationary signals, of which BLUETOOTH is an example. Therefore, although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A method of estimating a pitch period of a signal, the method comprising:
identifying a peak candidate of the signal as a peak; and
estimating the pitch period of the signal based on a time difference between the identified peak and a previous peak of the signal.

2. The method of claim 1, wherein the signal is a quasi-stationary signal.

3. The method claim 1, wherein the step of identifying the peak candidate as the peak comprises determining if a value of the peak candidate exceeds a threshold.

4. The method of claim 3, wherein the threshold is based on at least one of a value of a latest peak, an elapsed time since the latest peak, and a previously-estimated pitch period.

5. The method of claim 4, wherein a value of the threshold is lowered in windows located where a peak is expected.

6. The method of claim 5, wherein the windows are located at multiples of the previously-estimated pitch period.

7. The method of claim 5, wherein, after a window, the value of the threshold is returned to a value of the threshold immediately prior to the lowering of the threshold value in the window.

8. The method of claim 6, wherein, if no peak is found in a current window, the threshold is further lowered in a subsequent window.

9. The method of claim 4, wherein the threshold is reset to a default value if no peaks have been found in a time interval.

10. The method of claim 9, wherein the time interval is pre-defined.

11. The method of claim 9, wherein the time interval is adaptive.

12. The method of claim 10, wherein the time interval is reset momentarily.

13. The method of claim 10, wherein the time interval is reset gradually.

14. The method of claim 11, wherein the time interval is reset momentarily.

15. The method of claim 11, wherein the time interval is reset gradually.

16. The method of claim 1, wherein a signal value is a peak candidate if the signal value exceeds a previous peak candidate value and a pre-defined time period has elapsed since a most recent identified peak.

17. The method of claim 3, wherein the step of identifying the peak candidate as a peak comprises determining if a first zero crossing following the peak candidate has occurred.

18. The method of claim 17, wherein the step of determining the pitch period comprises measuring a time difference between zero crossings following consecutive identified peaks.

19. The method of claim 1, wherein the time difference is a multiple of the estimated pitch period.

20. The method of claim 18, wherein the time difference is a multiple of the estimated pitch period.

21. The method of claim 1, wherein each of the identified peak and the previous peak is a negative peak.

22. The method of claim 1, wherein each of the identified peak and the previous peak is a positive peak.

23. The method of claim 1, wherein the step of estimating comprises:
calculating two estimations of the pitch period;
wherein a first estimation is for positive signal values and a second estimation is for negative signal values; and
wherein the estimated pitch period is based on at least one of the first estimation, the second estimation, and a previously-estimated pitch period.

24. The method of claim 1, wherein the method is performed relative to an ad hoc wireless network.

25. The method of claim 1, wherein the method is performed responsive to loss or corruption of data.

26. An error-concealment apparatus comprising:
a history block for storing signal data input to a decoder;
an error likelihood detector for directing an input of the decoder to data of the signal data in the history block offset an estimated signal pitch period back in time responsive to a determination that data from a receiver has been lost or corrupted;
a pitch period estimator for estimating the pitch period of the signal data via identification of peaks of the signal data; and
wherein the pitch period estimator is operative to:
identify a peak candidate of the signal data as a peak; and
determine a time difference between the identified peak and a previous peak of the signal data.

27. The apparatus of claim 26, wherein a signal value is a peak candidate if the signal value exceeds a previous peak candidate value and a pre-defined time period has elapsed since a most recent identified peak.

28. The apparatus of 26, wherein identification of the peak candidate as the peak comprises determining if a value of the peak candidate exceeds a threshold.

29. The apparatus of claim 28, wherein the threshold is based on at least one of a value of a latest peak, an elapsed time since the latest peak, and a previously-estimated pitch period.

30. The apparatus of claim 29, wherein:
a value of the threshold is lowered in windows located where a peak is expected; and
the windows are located at multiples of the previously-estimated pitch period.

31. The apparatus of claim 30, wherein, after a window, the value of the threshold is returned to a value of the threshold immediately prior to the lowering of the threshold value in the window.

32. The apparatus of claim 30, wherein, if no peak is found in a current window, the threshold is further lowered in a subsequent window.

33. The apparatus of claim 29, wherein the threshold is reset to a default value if no peaks have been found in a time interval.

34. The apparatus of claim 26, wherein the identification of the peak candidate as a peak comprises determining if a first zero crossing following the peak candidate has occurred.

35. The apparatus of claim 26, wherein the estimation of the pitch period comprises measuring a time difference between zero crossings following consecutive identified peaks.

36. The apparatus of claim 26, wherein each of the identified peak and the previous peak is a negative peak.

37. The apparatus of claim 26, wherein each of the identified peak and the previous peak is a positive peak.

38. The apparatus of claim 26, wherein the pitch period estimator is operative to:
calculate two estimations of the pitch period;
wherein a first estimation is for positive signal values and a second estimation is for negative signal values; and
wherein an estimated pitch period is based on at least one of the first estimation, the second estimation, and a previously-estimated pitch period.

39. The apparatus of claim 26, wherein the apparatus is part of an ad hoc wireless network.

40. The apparatus of claim 26, wherein the pitch period estimator is adapted to:
determine a time difference between the identified peak and the previous peak;
wherein the identified peak and the previous peak are of the same polarity; and
wherein the previous peak and the identified peak are consecutive peaks.

41. The apparatus of claim 26, further comprising a decision block operative to detect whether the signal data is quasi-stationary, enable the pitch period estimator if the signal data is quasi-stationary, and disable the pitch period estimator if the signal data is not quasi-stationary.
